(19) United States
(12) Patent Application Publication
(10) Pub. No.: US 2008/0243650 A1
(43) Pub. Date: Oct. 2, 2008

(54) Service System and Method for Mobile Payment of Small Amount Using Virtual Caller Id

(76) Inventor: Sahng Ho Yoon, Seoul (KR)

Correspondence Address: LADAS & PARRY LLP, 224 SOUTH MICHIGAN AVENUE, SUITE 1600, CHICAGO, IL, 60604, US

(21) Appl. No.: 11/547,065

(22) PCT Filed: Mar. 29, 2005
(86) PCT No.: PCT/KR05/00907

§ 371 Date: Sep. 28, 2006

(30) Foreign Application Priority Data
Mar. 30, 2004 (KR) 10-2004-0021669

(51) Int. Cl. G06Q 20/00; H04Q 7/20; G06Q 10/00

(52) U.S. Cl. 705/30; 705/44; 455/466

(57) ABSTRACT

The present invention relates to a mobile micropayment service system and method using a virtual caller ID. According to a micropayment service system and method of the present invention, a user can use mobile micropayment service not only without providing the personal information of the user to a mobile PG center but also by transmitting a short message, and each mobile network operator directly manages the bill particulars information with respect to the mobile micropayment without depending on the mobile PG center.

### TECHNICAL FIELD

The present invention relates to a mobile micropayment system and method using virtual caller identification (ID), and more particularly, to a mobile micropayment system and method using virtual caller ID such that a user can charge a deposit via transmitting a short message to a certain virtual caller ID.

### BACKGROUND ART

A mobile micropayment service means that a mobile communication terminal is used as a payment means for using contents of a member company and a bill for using contents of the member is added to a bill for using a mobile communication terminal of a user. For example, there is an approval number transmitting/receiving method as a typical mobile micropayment service.

In the approval number transmitting/receiving method, when a user is connected to a server of a member company and requests a mobile micropayment, a mobile payment gateway (PG) center receives and checks predetermined personal authentication information, a mobile communication terminal number of the user, and requested payment amount input by the user, generates an approval number, and transmits the approval number to the mobile communication terminal. The user of the mobile communication terminal receiving the approval number inputs the approval number via the server of the member. The mobile PG center compares the input approval number with the approval number transmitted by the mobile PG center and approves.

The conventional mobile micropayment service method as described above has defects in which personal information of a user is provided to the mobile PG center, and it is troublesome that the described procedure must be always performed when mobile micropayment is performed.

Also, in the conventional mobile micropayment service method, the mobile PG center maintains a call center, and each mobile network operator providing a micropayment service obtains charge particulars information depending on the mobile PG center.

### DISCLOSURE OF INVENTION

### Technical Goals

To solve the defects and problems of the conventional art, the present invention provides a mobile micropayment service system and method in which personal information is not provided to a mobile PG center, the procedure of mobile micropayment can be simplified, each mobile network operator can manage the charge particulars information on the mobile micropayment without depending on the mobile PG center.

### Technical Solutions

According to an aspect of the present invention, there is provided a mobile micropayment service system using a virtual caller ID, including: a mobile PG center receiving mobile communication terminal number information and charge amount information with respect to predetermined deposit of a user from a server of a predetermined member company, generating and storing charge information including the mobile communication terminal number information, the charge amount information, and identification information of the member company, and transmitting the charge information to a predetermined server; a micropayment SMS server receiving the charge information from the mobile PG center, generating a short payment request message, whose calling number is a virtual caller ID, including the member company identification information, the charge amount information, and a predetermined identification information, wherein the identification information is a predetermined number information for receiving a short message from the mobile communication terminal of the user, and transmitting the short payment request message to the mobile communication terminal of the user, wherein when a short message whose called number is the virtual caller ID is received from the mobile communication terminal, the micropayment SMS server transmits an SMS reception acknowledgment message in response to the short message to the mobile PG center, and when the SMS reception acknowledgment message if received, the mobile PG center transmits a approval message of the approval with respect to the charged deposit to the mobile PG center.

According to another aspect of the present invention, there is provided is a mobile micropayment service method for charging a deposit, of a mobile micropayment service system using a virtual caller ID, the system comprising a micropayment SMS server receiving a short message of a certain virtual caller ID for mobile micropayment from any one of an switch of a mobile communication system and a short message service center, a mobile PG center connected to the micropayment SMS server and a plurality of member company servers, the mobile PG center comprising a charge information database storing user mobile communication terminal number information, member company identification information, and charge amount information, the method including: a first step of transmitting mobile communication terminal number information, member company identification information, and charge amount information to the micropayment SMS server when the mobile PG center receives the mobile communication terminal number information of the user and the charge amount information from the member company server for the mobile micropayment; a second step of transmitting a short payment request message whose calling number is a virtual caller ID, the message including the member company identification information and the charge amount information and requesting a short message replying to the mobile communication terminal by the micropayment SMS server; a third step of transmitting an SMS reception acknowledgment message including number information of mobile communication terminal transmitting a short message, member company identification information included in the virtual caller ID, and the charge amount information to the mobile PG center in case that the micropayment SMS server receives a payment acknowledgement short message transmitted from the mobile communication terminal to the virtual caller ID via the switch or short message service center; and a fourth step of checking whether charge information including mobile communication terminal information, member company identification information, and charge amount information received from the micropayment SMS server to the mobile PG center exists in the charge information database and transmitting an approval message including user mobile communication terminal number information and the charge amount information to the member company server in case that the charge information exists in the charge information database, wherein the member company server receiving the approval message from the mobile PG center charges the deposit.

### BRIEF DESCRIPTION OF DRAWINGS

FIG. 1 is a network configuration diagram of a mobile micropayment service system according to an embodiment of the present invention, which uses a virtual caller ID;

FIG. 2 is a configuration diagram of a server of a member company of FIG. 1;

FIG. 3 is a configuration diagram of a mobile PG center of FIG. 1;

FIG. 4 is a configuration diagram of a micropayment short message service (SMS) server of FIG. 1;

FIG. 5 is diagram illustrating examples of a virtual caller ID according to the present invention;

FIG. 6 is a flow chart sequentially illustrating a first process of charging a deposit of a mobile micropayment service method according to an embodiment of the present invention;

FIG. 7 is a flow chart sequentially illustrating a second process of charging a deposit of the mobile micropayment service method according to an embodiment of the present invention;

FIG. 8 is a flow chart sequentially illustrating a process of canceling charge of the mobile micropayment service method according to an embodiment of the present invention; and

FIG. 9 is a flow chart sequentially illustrating a process of charging a deposit as a present of the mobile micropayment service method according to an embodiment of the present invention.

### BEST MODE FOR CARRYING OUT THE INVENTION

The details with respect to the goals, technical constitution, and effects according to the same of the present invention will be understood by detailed description with reference to the drawings illustrating preferable embodiments of the present invention.

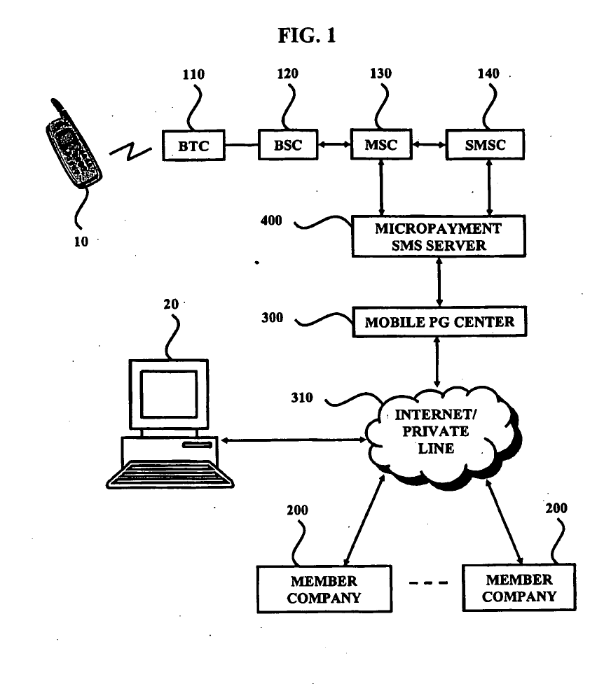

FIG. 1 is a network configuration diagram of a mobile micropayment service system using a virtual caller ID according to an embodiment of the present invention, and each component forming the system is schematically described as following.

As shown in FIG. 1, the mobile micropayment service system of the present invention, which uses a virtual caller ID, includes a mobile communication system including a base station 110 for radio communication with a mobile communication terminal 10, a base station controller 120, a switch 130, and short message service center 140, a micropayment SMS server 400 connected to the switch 130 of the mobile communication system and SMS center 140, a mobile payment gateway (PG) center 300 connected to the micropayment SMS server 400, and a plurality of member company servers 200 connected to the mobile PG center 300 via Internet or a private line 310 and providing a mobile micropayment service.

When mobile communication terminal number information and charge amount information is received from the member company server 200, the mobile PG center 300 stores charge information including member company identification information, the mobile communication terminal number information, and the charge amount information and transmits the member company identification information, the mobile communication terminal number information, and the charge amount information to the micropayment SMS server 400 to request payment.

When an SMS reception acknowledgment message is received from the mobile PG center 300, the micropayment SMS server 400 transmits a short payment request message using a virtual caller ID including the member company identification information and the charge amount information as a calling number to the mobile communication terminal 10.

Also, the short message using the virtual caller ID as the called number is received from the mobile communication terminal 10 via the switch 130 or the short message service center 140, the micropayment SMS server 400 transmits the SMS reception acknowledgment message to the mobile PG center 300 such that the mobile PG center 300 transmits an approval message to the member company server 200 according to the SMS reception acknowledgment message to perform the charge.

A plurality of the micropayment SMS servers 400 may exist for each mobile network operator. In this case, the mobile PG center 300 may divide the mobile network operators according to the mobile communication terminal number of a user and transmit to the micropayment SMS server 400 of the mobile network operator.

On the other hand, the virtual caller ID of the present includes identifier information used such that the micropayment SMS server 400 can receive a message, for example, “070” or “*”, the member company identification information, and the charge amount information. When a user transmits a short message using the virtual caller ID, charge, charge cancellation, and deposit presentation may be performed by acquiring information requested by the user from the virtual caller ID.

For example, the virtual caller ID may be a number “07012343000 in which an identifier “070” used such that the micropayment SMS server 400 can receive a message, an identification number “1234” as identification information of the member company, and a number “3000” indicating charge amount are sequentially combined. In this case, an identifier, for example, “#” may be further included in order to distinguish between the number “1234” indicating the member company identification information and the number “3000” indicating the charge amount.

Also, for another example, the virtual caller ID may be a number “1234*3000” in which an identification number “1234” of the member company, and an identifier “*” used such that the micropayment SMS server 400 can receive a message, and a number “3000” indicating the charge amount are sequentially combined.

According to the constitution of the virtual caller ID, when transmission of a short message using the virtual caller ID constituted like the embodiment as a called number is requested by the mobile communication terminal 10 of the user, any one of the switch 130 of the mobile communication system and the short message service center 140 has to transmit the short message to the micropayment SMS server 400. The virtual caller ID may be generated by any one or each of the mobile PG center 300, the micropayment SMS server 400, and the member company server 200.

That is, in case of the virtual caller ID beginning with “070”, when a short message whose called number begins with the “070” is transmitted from the mobile communication terminal of the user, the switch 130 transmits the short message to the micropayment SMS server 400. When the virtual caller ID whose identifier is “1”, such as “1234*3000” is received, the short message service center 140 may distinguish the virtual caller ID and transmit the short message to the micropayment SMS server 400.

When a short message whose called number is the virtual caller ID as described above is received from a certain mobile communication terminal 10 via the switch 130 or the short message service center 140, the micropayment SMS server 400 and the mobile PG center 300 analyze the virtual caller ID according to a predetermined rule and transmit the request information to the member company server 200. Therefore, the member company server 200 can charge the amount requested by the user in the deposit account via mobile micropayment, cancel the charge, or charge a deposit in a deposit account of another user as a present.

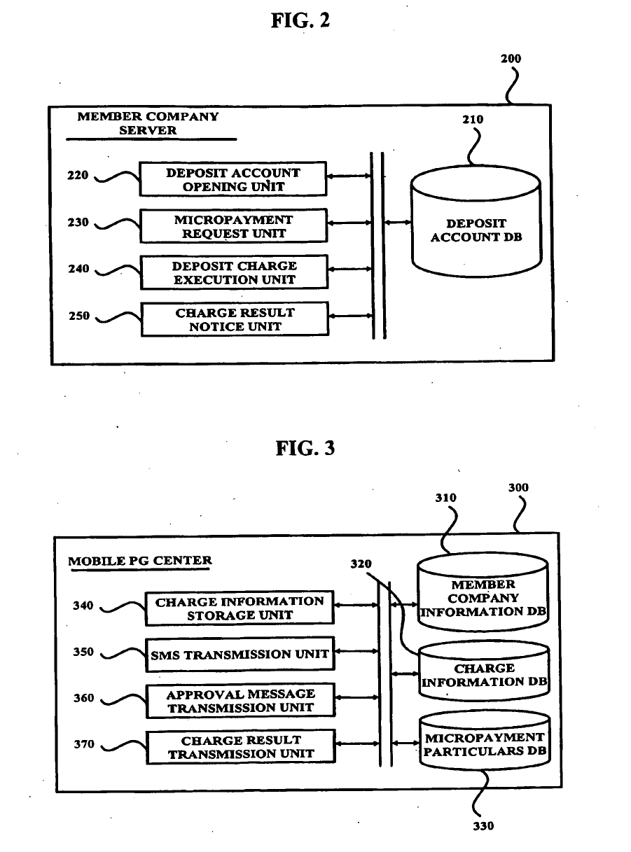

The each component forming the mobile micropayment system of the present invention described with reference to FIG. 1 will be described with reference to the FIGS. 2 through 4 as following.

FIG. 2 is a configuration diagram of the member company server of FIG. 1. The member company server 200 includes a deposit account database 210, a deposit account opening unit 220, a micropayment request unit 230, a deposit charge execution unit 240, and a charge result notice unit 250.

The deposit account database 210 stores deposit account information such as deposit charge particulars information, deposit usage account information, and deposit balance information for each user.

When deposit charge is initially requested by a user terminal 20 connected via Internet 310, the deposit account opening unit 220 opens a deposit account of a user and stores opened deposit account information in the deposit account database 210.

When mobile micropayment is requested by the user terminal 20 connected via Internet 310, the micropayment request unit 230 checks whether a deposit account of the user exists in the deposit account database 210 and transmits the mobile communication terminal number information of the user for the mobile micropayment and the charge amount information requested by the user to the mobile PG center 300.

If a user requests cancellation of deposit charge, the micropayment request unit 230 has to further transmit an identifier “*” indicating charge cancellation. When a user inputs a mobile communication terminal number of another user to request deposit charge as a present, the mobile communication terminal number of another user, in which the deposit is charged, has to be further transmitted.

When an approval message is received from the mobile PG center 300, the deposit charge execution unit 240 charges the charge amount requested by the user in the deposit account of the user or cancels the charge and corrects deposit balance information and charge particulars information of the deposit account database 210.

The approval message includes mobile communication terminal number information and charge amount information of the user and further includes charge cancellation identifier information in case of charge cancellation and mobile communication terminal number information of a user, in which a deposit as a present is charged, in case of deposit presentation.

The charge result notice unit 250 transmits result information of charge process, charge cancellation process, and deposit presentation process performed by the deposit charge execution unit 240 to the mobile PG center 300 such that the mobile PG center 300 processes information according to the charge process result.

Also, the charge result notice unit 250 may transmit the charge process result information to any one of the terminal 20 and the mobile communication terminal 10 of the user.

FIG. 3 is a configuration diagram of the mobile PG center illustrated in FIG. 1.

As shown in FIG. 3, the mobile PG center 300 may include a database including a member company information database 310, a charge information database 320, and micropayment particulars database 330, a charge information storage unit 340, an SMS transmission request unit 350, an approval message transmission unit 360, and a charge result transmission unit 370.

The member company information database 310 stores a plurality of pieces of member company identification information, and the member company identification information that is an identification number formed with predetermined digits allocated for each member company is used for generating a virtual caller ID.

The charge information database 320 stores charge information for each user, and the charge information includes mobile communication terminal number information of the user requesting charge, identification information of a member company transmitting the mobile communication terminal number information of the user, and requested charge amount information. Accordingly, the charge information with respect to one mobile communication terminal number of the user may include a plurality of pieces of the charge information whose the member company identification information and requested charge amount information are different respectively.

The micropayment particulars database 330 stores information of micropayment particulars performed according the charge information stored in the charge information database 320, and the micropayment particulars information may include mobile communication terminal number information, member company identification information, charge or charge cancellation amount information, and process result information.

On the other hand, the micropayment SMS server 400 may manage the micropayment particulars in the present invention. When the micropayment particulars are managed by the micropayment SMS server 400, the micropayment particulars database 330 of the mobile PG center may be excluded from the present system.

Next, when mobile communication terminal number of the user and requested charge amount information are received from the member company server 200, the charge information storage unit 340 generates charge information including the mobile communication terminal number information, the member company identification information, and the requested charge amount information based on the received information and stores the generated charge information in the charge information database 320.

The charge information stored as described above is checked again when an SMS reception acknowledgment message is received from the micropayment SMS server 400. In case that the charge information is once checked, charge or charge cancellation with respect to the SMS reception acknowledgment message can be performed.

Next, when the storing the charge information in the charge information database 320 is finished, the SMS transmission request unit 350 transmits mobile communication terminal number information, member company identification information, charge amount information to the micropayment SMS server 400 according to the charge information. The micropayment SMS server 400 can generate a virtual caller ID by using the received information, transmit a short message to the mobile communication terminal 10 by using the virtual caller ID, and receive a short message from the mobile communication terminal 10 via the virtual caller ID.

In case of charge cancellation, the SMS transmission request unit 350 transmits charge cancellation identifier information in addition to the mobile communication terminal number information, the member company identification information, and the charge amount information to the micropayment SMS server 400. In case of deposit presentation, mobile communication terminal number of another user, in which a deposit is charged, is further transmitted. In this case, the micropayment SMS server 400 may generate a virtual caller ID including all information, excluding the mobile communication terminal number information of the user, a payer, transmitted from the SMS transmission request unit 350.

On the other hand, when an SMS reception acknowledgment message is received from the micropayment SMS server 400 after the micropayment SMS server 400 receives a short message from the mobile communication terminal 10, the approval message transmission unit 360 checks whether the charge information exists in the charge information database 320 and transmits an approval message requesting to charge the amount requested by the user to the member company server 200.

That is, the SMS reception acknowledgment message includes the mobile communication terminal number information of the user, member company identification information, and the requested charge amount information, and the approval message transmission unit 360 checks whether the charge information including each information included in the SMS reception acknowledgment message is previously stored in the charge information database 320.

If charge information corresponding to the check result does not exist, the approval message transmission unit 360 may transmit a message notifying that the charge can not be performed because the charge information does not exist to the micropayment SMS server 400.

On the other hand, in case of charge cancellation, the SMS reception acknowledgment message may further include charge cancellation identifier information, and in case of deposit presentation, mobile communication terminal number information of a user receiving a deposit may be further included. However, in this case, the checking the charge information may be performed considering the mobile communication terminal number information of the user, the member company identification information, and the charge amount information.

The approval message includes the mobile communication terminal number information of the user and the charge amount information. The charge cancellation identifier information is further included in case of charge cancellation, and the mobile communication terminal number information of the user, in which a deposit is charged, is further included in case of deposit presentation.

Next, when charge process result information is received from the member company server 200 receiving the approval message, the charge result transmission unit 370 transmits the received charge result information to the micropayment SMS server 400 such that information process is performed according to the charge result.

In this case, the charge result transmission unit 370 can store and manage the micropayment particulars information in the micropayment particulars database 330 for each the charge result received from the member company server 200.

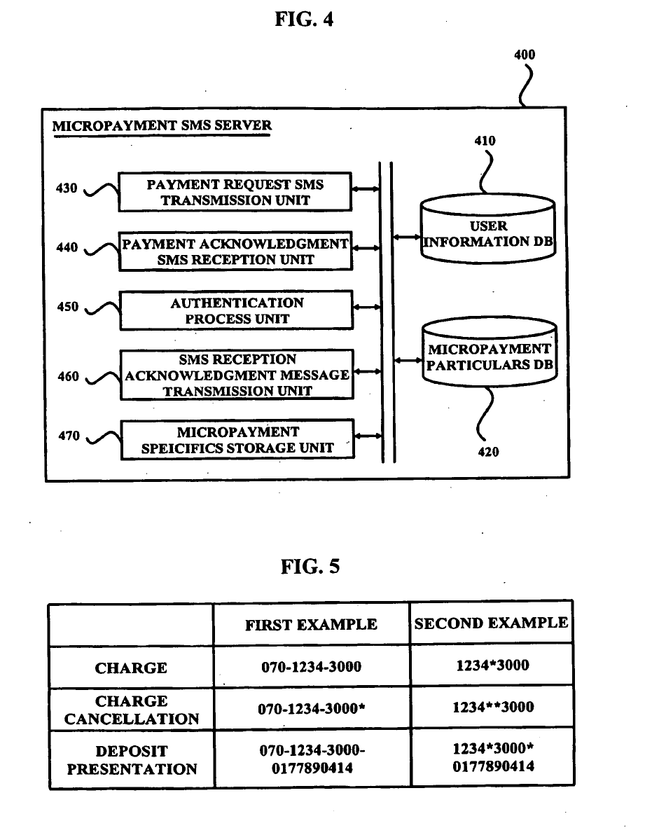

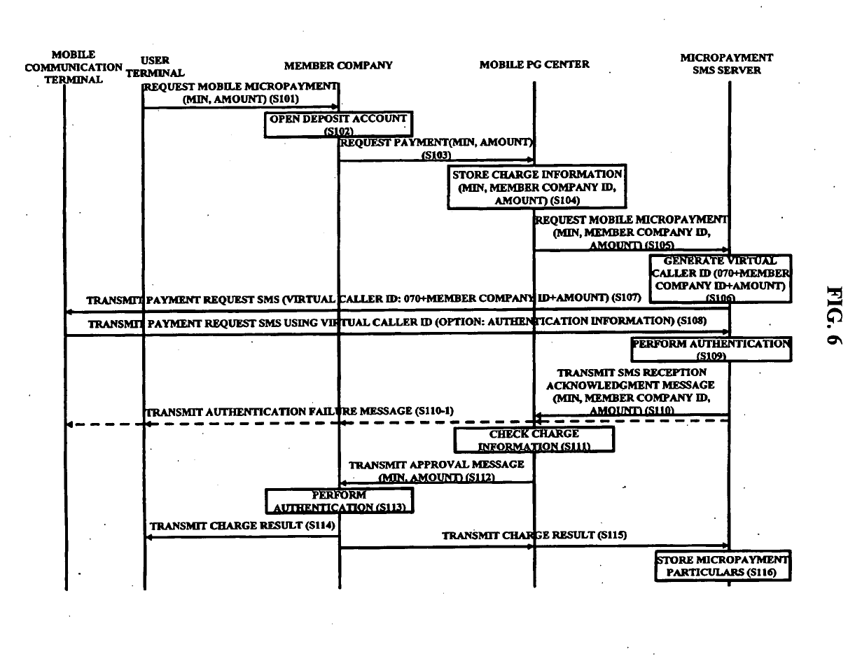

FIG. 4 is a configuration diagram of the micropayment SMS server of FIG. 1.

As shown in FIG. 4, the micropayment SMS server 400 may include a user information database 410, a micropayment particulars information database 420, a payment request SMS transmission unit 430, a payment acknowledgment SMS reception unit 440, an authentication process unit 450, an SMS reception acknowledgment message transmission unit 460, and a micropayment particulars storage unit 470.

The user information database 410 stores authentication information for each user for mobile payment. A micropayment password determined by a user or a resident registration number of the user may be included in the authentication information, and the authentication information may be omitted according to whether authentication is required.

The micropayment particulars database 420 stores micropayment particulars information including the mobile communication number information, the member company identification information, and the charge amount information, like the micropayment particulars database 330 of the mobile PG center 300. The stored micropayment particulars information may be used later for totally demanding in case that a mobile communication terminal use fee of a user is demanded.

When the mobile communication terminal number information, the member company identification information, and the charge amount information are received from the mobile PG center 300, the payment request SMS transmission unit 430 generates a virtual caller ID in which the member company identification information, requested charge amount information, and a predetermined identifier, for example, “070” or “*”, are combined and transmits a short payment request message requesting a short message replying to the virtual caller ID to the mobile communication terminal 10 according to the mobile communication terminal number information received from the mobile PG center 300.

In case of charge cancellation, the payment request SMS transmission unit 430 further receives charge cancellation identifier information from the mobile PG center 300. In case of deposit presentation, the payment request SMS transmission unit 430 further receives mobile communication terminal number information of a user receiving a deposit present. In this case, the payment request SMS transmission unit 430 may generate a virtual caller ID further including the received information.

Next, when a short payment acknowledgment message whose called number is the virtual caller ID generated by the payment request SMS transmission unit 430 is received from the mobile communication terminal 10, the payment acknowledgment SMS reception unit 440 acquires the virtual caller ID including the information for the mobile micropayment.

In this case, when a charge service according to the information of the virtual caller ID is initially used, the user receives the short payment request message from the payment request SMS transmission unit 430 and transmits a short payment acknowledgment message to the virtual caller ID of the received short payment request message. Then, the user may directly transmit a short message, a short payment acknowledgment message, requesting for charge to the micropayment SMS server 400 via the virtual caller ID previously generated.

Next, the SMS reception acknowledgment message transmission unit 460 receives the number information of the mobile communication terminal transmitting the message, the virtual caller ID information acquired from the message from the payment acknowledgment SMS reception unit 440, acquires the member company identification information and the charge amount information from the virtual caller ID, and transmits an SMS reception acknowledgment message including the number information of the mobile communication terminal transmitting the message and the acquired information to the mobile PG center 300.

In case of charge cancellation or deposit presentation, the SMS reception, acknowledgment message transmission unit 460 further acquires charge cancellation identifier information or mobile communication terminal number information of another user receiving a deposit present from the virtual caller ID. Accordingly, the SMS reception acknowledgment message further includes the charge cancellation identifier information in case of the charge cancellation or the mobile communication terminal number information of the user receiving the deposit present in case of the deposit presentation.

The micropayment particulars storage unit 470 receives charge result information transmitted from the member company server 200 via the mobile PG center 300 and stores and manages information of micropayment and payment cancellation particulars according to the charge result for later bill.

Also, the micropayment particulars storage unit 470 may transmits a short message including the micropayment particulars information to the mobile communication terminal 10 of the user.

On the other hand, in case that authentication process is required, the mobile micropayment service system using the virtual caller ID of the present invention may include the authentication process unit 450. In this case, the payment request SMS transmission unit 430 may transmit a short payment request message requesting that authentication information of the user is input to reply the message to the mobile communication terminal 10. Also, when a short payment acknowledgment message including the authentication information is received from the mobile communication terminal 10 of the user, the payment acknowledgment SMS reception unit 440 transmits the authentication information included in the short payment acknowledgment message to the authentication process unit 450 to request authentication process.

The authentication process unit 450 compares the authentication information included in the short payment acknowledgment message transmitted from the mobile communication terminal 10 of the user with the authentication information of the user stored in the user information database 410 to process authentication and transmits the authentication result to the SMS reception acknowledgment message transmission unit 460. The described above may be omitted according to whether the authentication process is required.

In case of requiring the authentication process, the SMS reception acknowledgment message transmission unit 460 transmits an SMS reception acknowledgment message to the mobile PG center 300 only when the authentication is successively performed by the authentication process unit 450. When the authentication fails, an authentication failure message should be transmitted to the mobile PG center 300 or the mobile communication terminal 10.

On the other hand, in the description of the mobile micropayment service system using a virtual caller ID in the embodiment, it is mainly described that a user charges the deposit account of his own. The each component forming the system may perform the process of charge, charge cancellation, deposit presentation by making different information of the virtual caller ID, and examples of the virtual caller ID will be described with reference to FIG. 5 as following.

FIG. 5 is a diagram illustrating examples of the virtual caller ID according to the present invention.

Referring to FIG. 5, a first example has an identifier “070” used such that the micropayment SMS server 400 can receive a short message for micropayment from the mobile communication terminal 10.

A virtual caller ID for charging deposit in the deposit account of the user may be composed like “070-1234-3000” in which an identifier, member company identification information, and charge amount information are combined. A virtual caller ID for canceling charge may be composed like “070-1234-3000*” in which an identifier with respect to the charge cancellation is added. A virtual caller ID for deposit presentation may be composed like “070-1234-3000-0177890414” in which mobile communication terminal number information of a user receiving a deposit is added.

Also, a second example has an identifier “*” used such that the micropayment SMS server 400 receives a short message for micropayment from the mobile communication terminal 10. A virtual caller ID for charging a deposit in a deposit account of a user may be composed like “1234*3000”. A virtual caller ID for canceling charge may be composed like “1234**3000”. A virtual caller ID for deposit presentation may be composed like “1234*3000*01778901414”.

On the other hand, the operation of the each component according to a deposit presentation request is described as following.

The member company server 200 receives mobile communication terminal number information and charge amount information of a user A performing micropayment and mobile communication terminal number information of another user B receiving a deposit, checks a deposit account with respect to the user B, and transmits the mobile communication terminal number information of the user A, the charge amount information, and the mobile communication terminal number information of the user B to the mobile PG center 300.

The mobile PG center 300 stores the mobile communication terminal number information of the user A, member company identification information, charge information based on the charge amount information in the charge information database and transmits the mobile communication terminal number information, the member company identification information, the charge amount information, and the mobile communication terminal number information of the user B.

The micropayment SMS server 400 generates a virtual caller ID including the member company identification information, the charge amount information, the mobile communication terminal number information of the user B, and a predetermined identifier, for example, “070” or “1”, and transmits a short payment request message using the virtual caller ID as a calling number to the mobile communication terminal of the user A.

When the short payment acknowledgment message is received from the mobile communication terminal of the user A, the micropayment SMS server 400 acquires the member company identification information, the charge amount information, the mobile communication terminal number information of the user B and transmits the acquired information and the mobile communication terminal number information of the user A to the mobile PG center 300.

The mobile PG center 300 checks the charge information based on the received information and transmits an approval message including the mobile communication terminal number information of the user A, the charge amount information, the mobile communication terminal number information of the user B to the member company server 200 to request charge. The member company server 200 charges the charge amount to the deposit account of the user B.

As described above, the mobile PG center 300 and the micropayment SMS server 400 analyze the virtual caller ID such that the charge, charge cancellation, deposit presentation requested by the user may be performed. The user stores the virtual caller ID as described with reference to FIG. 5 in the phone number storage unit of own mobile communication terminal in order to simply charge a deposit to his own deposit account, canceling charge, and presenting a deposit to another user via transmitting a short message to the virtual caller ID.

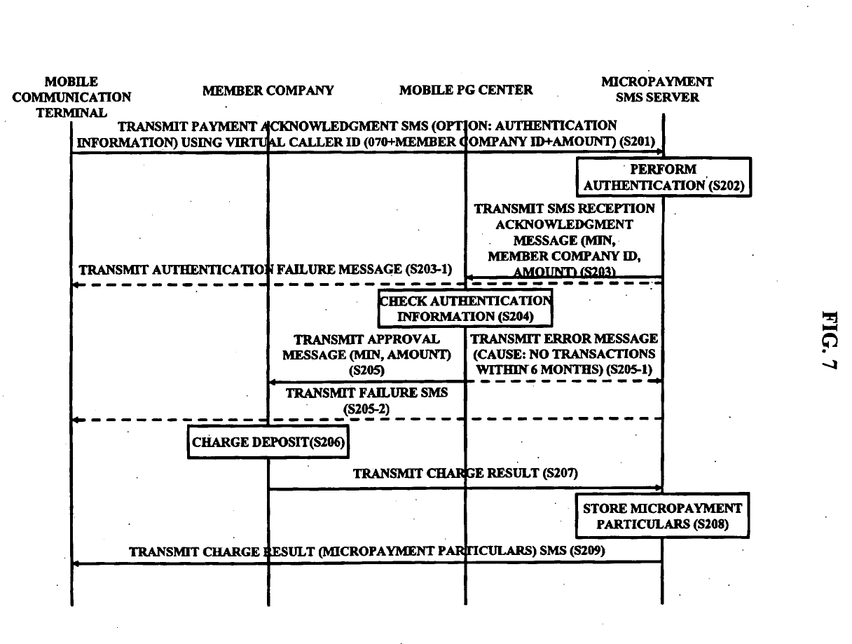

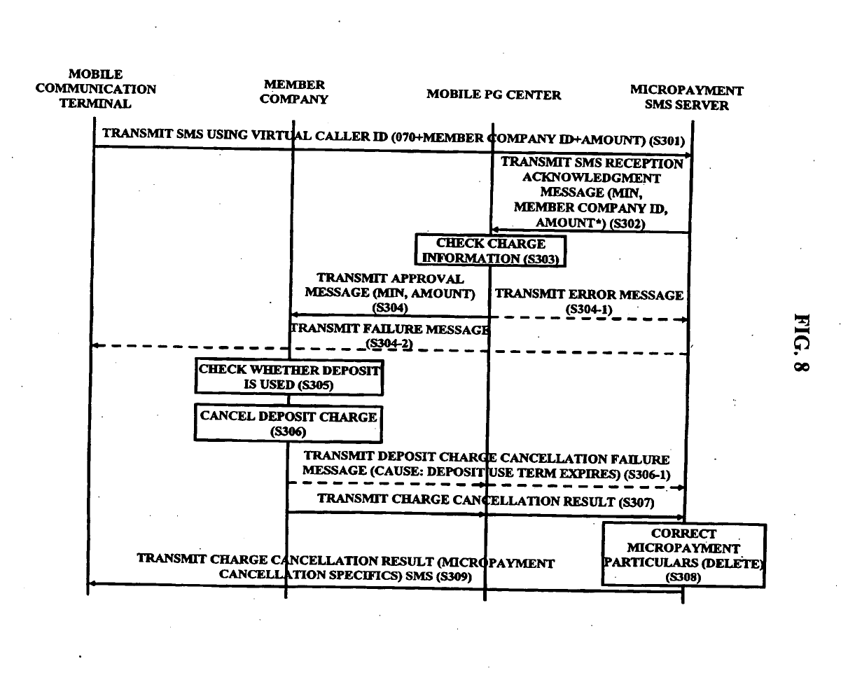

On the other hand, a mobile micropayment service process with respect to deposit charge of the mobile micropayment service system using the virtual caller ID of the present invention is described with reference to FIGS. 6 and 7 as following.

In the present invention, a user transmits a short message using a virtual caller ID, thereby charging a deposit. A process of charging a deposit may be divided into a first deposit charge process of FIG. 6, in which a user initially charges a deposit via a certain member company server when the user initially uses a mobile micropayment service in the member company server, and a second deposit charge process of FIG. 7, in which the user directly transmits a short message to the virtual caller ID acquired by performing the first deposit charge process, thereby charging a deposit.

FIG. 6 is a flow chart sequentially illustrating the first deposit charge process of a mobile micropayment service method according to an embodiment of the present invention. In the flow chart, a user initially uses mobile micropayment via the member company server 200. Though a process in which a deposit is charged to the deposit account of the user is shown in FIG. 6, charge cancellation or deposit presentation is described with reference to FIG. 6.

Referring to FIG. 6, when a mobile communication terminal 20 of a user connected to the member company server 200 via Internet 310 transmits mobile communication terminal number information of the user and requested charge amount information to the member company server 200 to request mobile micropayment (S101), a deposit account of the user is opened (S102) and the information is stored in a deposit account database 210.

The process of opening the deposit account (S102) may be performed after the member company server 200 checks whether the deposit account of the user exists in the deposit account database 210 and the existence of the deposit account is ascertained.

Next, the member company server 200 transmits the mobile communication terminal number information of the user, the member company identification information, and requested charge amount information to the mobile PG center 300 to request payment (S103).

If the user want to charge a deposit in a deposit account of another user instead of own deposit account, the member company server 200 must receive mobile communication terminal number information of the another user receiving a deposit from the user, check the deposit account of the another user, and transmit the mobile communication terminal number information of the user, the requested charge amount information, and the mobile communication terminal number information of the another user that receives deposit present to the mobile-PG center 300 in case of requesting payment.

Also, when the user want to cancel the deposit previously charged in the deposit account of his own, the member company server 200 may transmit the mobile communication terminal number, the charge amount information, and information of a charge cancellation identifier indicating charge cancellation to the mobile PG center 300.

On the other hand, when the information of mobile communication terminal number of the user and the charge amount is transmitted from the member company server 200 to request payment, the mobile PG center 300 checks whether charge information including the member company identification information, the mobile communication terminal number information of the user, and the charge amount information exists in the charge information database. When the charge information does not exist, the mobile PG center generates charge information including the member company identification information, the mobile communication terminal number information of the user, and the charge amount information and stores the charge information in the charge information database 320 (S104).

Next, the mobile PG center 300 transmits the mobile communication terminal number information, the member company identification information, for example, ID or identification number, and the charge amount information to the micropayment SMS server 400 (S105).

The micropayment SMS server 400 generates a virtual caller ID 070-1234-3000 including the member company identification information 1234 and the charge amount information 3000 received from the mobile PG center 300 (S106) and transmits a short payment request message using the generated virtual caller ID to the mobile communication terminal (S107).

On the other hand, in case of canceling charge, the mobile PG center 300 further transmits a charge cancellation identifier information * to the micropayment SMS server 400, and the micropayment SMS server 400 generates a virtual caller ID 070-1234-3000* including the charge cancellation identifier information. In case of deposit presentation, the mobile PG center further transmits the mobile communication terminal number information of the user receiving a deposit, 0177890414, and the micropayment SMS server 400 generates a virtual caller ID 070-1234-3000-0177890414 including the number.

In the above embodiment, though the micropayment SMS server 400 generates a virtual caller ID, the mobile PG center 300 may generate the virtual caller ID. That is, the mobile PG center 300 generates a virtual caller ID including the member company identification information and the charge amount information and transmits the generated virtual caller ID information and the mobile communication terminal number information received from the member company server 200 to the micropayment SMS server 400 to request transmitting/receiving an SMS.

When an authentication procedure with respect to mobile micropayment is required, the micropayment SMS server 400 must request a reply including authentication information of the user via a short payment request message transmitted to the mobile communication terminal 10 of the user.

Next, when a short payment acknowledgment message using the virtual caller ID including the member company identification information and the charge amount information as a called number is received from the mobile communication terminal 10 (S108), the micropayment SMS server 400 acquires the member company identification information and the charge amount information from the virtual caller ID that is the called number of the short payment acknowledgment message and transmits an SMS reception acknowledgment message including the acquired information and number information of the mobile communication terminal transmitting the message to the mobile PG center 300 (S110).

If the charge cancellation identifier information or the mobile communication terminal number of the user receiving the deposit is included in the virtual caller ID, the SMS reception acknowledgment message further includes the charge cancellation identifier information or the mobile communication terminal number information of the user receiving the deposit.

In the above description, the micropayment SMS server 400 acquires the member company identification information and the charge amount information from the virtual caller ID that is the called number of the short payment acknowledgment message and transmits the acquired member company identification information and the charge amount information to the mobile PG center 300. However, the micropayment SMS server 400 may transmit the virtual caller ID as it is to the mobile PG center 300.

Also, when the authentication procedure is required, the micropayment SMS server 400 receives a short payment request message including authentication information from the mobile communication terminal 10 of the user and compares the authentication information included in the received message with authentication information of the user stored in the user information database 410 to perform authentication (S109). When the authentication is successively performed, the micropayment SMS server 400 transmits an SMS reception acknowledgment message to the mobile PG center 300 (S110).

If the authentication fails, the micropayment SMS server 400 transmits an authentication failure message to the mobile PG center 300 (S110-1) such that the authentication failure message can be transmitted to the user terminal 20 via the mobile PG center 300 and the member company server 200. However, the authentication failure message may be directly transmitted to the mobile communication terminal 10 of the user.

The authentication process is identically applied to the charge cancellation or the deposit presentation regardless of the charge cancellation identifier information or the mobile communication terminal number information of the user receiving the deposit.

On the other hand, the mobile PG center receiving the SMS reception acknowledgment message from the micropayment SMS server 400 checks whether the charge information including the mobile communication terminal number information of the user requesting payment and the member company identification information exist in the charge information database 320 (S111). When the charge information exists in the charge information database 320, the mobile PG center 300 transmits an approval message including the mobile communication terminal number information of the user and the charge amount information to the member company server 200 (S112).

The member company server 200 receiving the approval message charges a requested deposit to the deposit account of the user (S113), transmits charge result to the user terminal 20 (S114), and transmits charge result information ACK to the mobile PG center 300. The mobile PG center 300 transmits the charge result information ACK to the micropayment SMS server 400 (S115).

The approval message transmitted from the mobile PG center 300 to the member company server 200 further includes charge cancellation identifier information in case of charge cancellation or mobile communication terminal number information of a user receiving a deposit in case of deposit presentation. The member company server 200 distinguishes the received information and performs the processes of charge, charge cancellation, deposit presentation, respectively.

Next, the micropayment SMS server 400 receiving the charge result information stores the received charge result information in the micropayment particulars database 420 for later bill (S116). According to case, the mobile PG center 300 may store the charge result information in the micropayment particulars database 330 of the same to manage.

Also, the micropayment SMS server 400 may transmit a short message including the charge result information to the mobile communication terminal 10 of the user for acknowledgment of the user.

FIG. 7 is a flow chart sequentially illustrating the second deposit charge process of the mobile micropayment service method according to an embodiment of the present invention, in which the user directly transmits a short message to the micropayment SMS server 400 to request deposit charge after deposit charge is performed via the process of FIG. 6.

As illustrated, when a short message whose called number is a certain virtual caller ID including member company identification information and charge amount information is received from the mobile communication terminal 10 of the user (S201), the micropayment SMS server 400 transmits an SMS reception acknowledgment message including information of the virtual caller ID that is the called number of the short message and number information of the mobile communication terminal 10 transmitting the message to the mobile PG center 300 (S203).

As described above with reference to FIG. 6, in case that predetermined authentication information is included in the short message received from the mobile communication terminal 10 of the user, the micropayment SMS server 400 performs authentication process with reference to the user information database 410 (S202), transmits the SMS reception acknowledgment message to the mobile PG center 300 when the authentication is successively performed (S203), and transmits an authentication failure message to the mobile communication terminal 10 of the user when the authentication fails (S203-1).

Next, the mobile PG center 300 receiving the SMS reception acknowledgment message checks whether the charge information of the member company of the user exists in the charge information database 320 based on the information received from the micropayment SMS server 400 (S204) and transmits an approval message requesting charging the amount requested by the user to the member company server 200 (S205).

If the charge information of the user does not exist in the charge information database 320, the mobile PG center 300 transmits an error message including error cause information to the micropayment SMS server 400 (S205-1), and the micropayment SMS server 400 transmits a short failure message including the error causer information to the mobile communication terminal 10 (S205-2).

Next, the member company server 200 receiving the approval message from the mobile PG center 300 charges the deposit requested by the user in the deposit account (S206) and transmits charge result information to the mobile PG center 300 (S207). The mobile PG center 300 transmits the charge result information received from the member company server 200 to the micropayment SMS server 400 (S207).

The micropayment SMS server 400 stores micropayment particulars information in the micropayment particulars database 420 according to the charge result information (S208) and transmits a short message including the charge result information to the mobile communication terminal 10 (S209).

On the other hand, in the embodiment, the virtual caller ID is generated by the micropayment SMS server 400. However, the virtual caller ID may be generated by the member company server 200 or the mobile PG center 300, and information transmitted and received between the components may be changed according to the generator of the virtual caller ID within the essential points of the present invention.

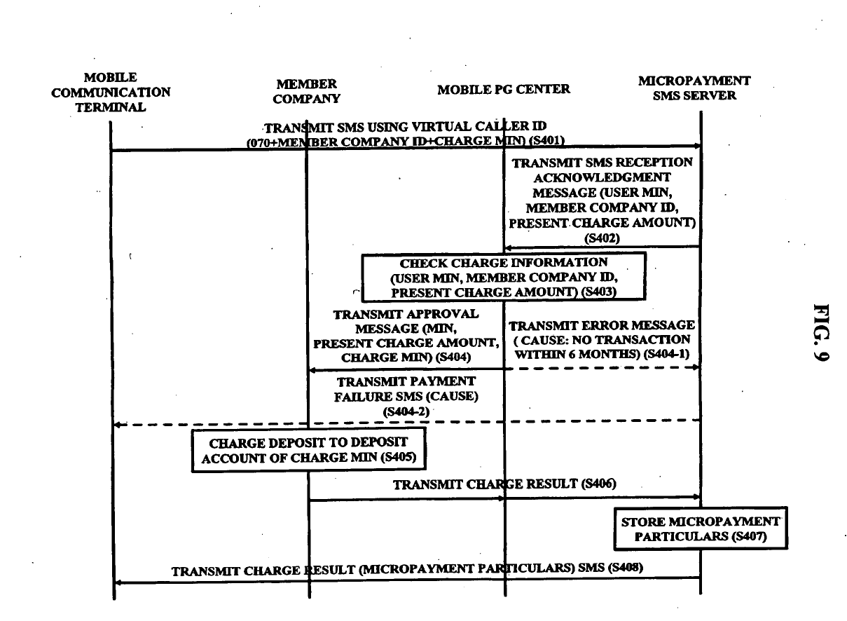

In the embodiment, the process in which a deposit is charged to the deposit account of the user himself is explained as an example of the mobile micropayment service process. However, the charge cancellation process and the process of presenting a deposit to the deposit account of another user may be simply embodied by changing the information transmitted and received between the each component and the virtual caller ID. Hereinafter, the processes of charge cancellation and deposit presentation are described with reference to FIGS. 8 and 9 as following.

FIG. 8 is a flow chart sequentially illustrating a process of charge cancellation of the mobile micropayment service method according to an embodiment of the present invention. A process in which a user directly transmits a short message for charge cancellation to the micropayment SMS server 400 is illustrated as FIG. 7.

As illustrated in FIG. 8, when a user transmits a short message using a virtual caller ID including a predetermined identifier, for example, “070” or “*”, member company identification information, charge cancellation amount information, and an identifier “*” indicating charge cancellation via the mobile communication terminal 10 of the user (S301), the micropayment SMS server 400 analyzes the virtual caller ID and transmits an SMS reception acknowledgment message including mobile communication terminal number information, the member company identification information, the charge cancellation amount information, and the identifier information to the mobile PG center 300 (S302).

In case that predetermined authentication information is included in the short message received from the mobile communication terminal 10 of the user, as described in the description of FIG. 6, the micropayment SMS server 400 may perform authentication process based on the user information database 410 before the SMS reception acknowledgment message is transmitted to the mobile PG center 300. The authentication process is not illustrated.

Next, the mobile PG center 300 receiving the SMS reception acknowledgment message checks whether charge information with respect to the member company of the user exists in the charge information database 320 based on the information received from the micropayment SMS server 400 (S303) and transmits an approval message, requesting charge cancellation with respect to the amount requested by the user, including the mobile communication terminal number information, the charge cancellation amount information, and the identifier information indicating the charge cancellation to the member company server 200 (S304).

In this case, the checked charge information includes the mobile communication terminal number information, the member company identification information, and the charge cancellation information without the identifier “*” indicating the charge cancellation. If the charge information stored in the charge information database 320 of the mobile PG center 300 according to the charge request of the user exists, the charge cancellation may be performed. According to case, as described in the description of FIG. 6, the charge cancellation via transmitting a short message may be performed only when the user requests charge cancellation via the member company server 200 and information with respect to the charge cancellation is stored in the charge information database 320 of the mobile PG center 300.

On the other hand, when the charge information of the user does not exist in the charge information database 320, the mobile PG center 300 transmits an error message including error causer information to the micropayment SMS server 400 (S304-1). The micropayment SMS server 400 transmits a short failure message including the error cause information to the mobile communication terminal 10 (S 304-2).

Next, the member company server 200 receiving the approval message from the mobile PG center 300 checks a deposit account of the user according to the information included in the approval message and checks whether deposit charge cancellation is possible based on the balance of the deposit and the term with respect to deposit charge cancellation (S305).

After the checking, in case that the cancellation of the charge of the deposit is possible, the member company server 200 performs the charge cancellation of the deposit charged in the deposit account of the user (S306) and transmits charge cancellation result information to the mobile PG center 300. The mobile PG center 300 transmits the charge cancellation result information received from the member company server 200 to the micropayment SMS server 400 (S307).

If the deposit whose charge cancellation is requested by the user is already used or the charge cancellation term expires, the member company server 200 transmits a deposit charge cancellation failure message including the failure cause information to the micropayment SMS server 400 via the mobile PG center 300 (S306-1).

Next, the micropayment SMS server 400 corrects or deletes the micropayment particulars information stored in the micropayment particulars database 420 according to the charge cancellation result information (S308) and transmits a short message including the charge cancellation result information that is micropayment cancellation particulars information to the mobile communication terminal 10 of the user (S309).

Finally, FIG. 9 is a flow chart sequentially illustrating a deposit presentation charge process of the mobile micropayment service method according to an embodiment of the present invention. In the process, a user presents a deposit to the deposit account of another user by transmitting a short message.

As illustrated in FIG. 9, when a user transmits a short message using a virtual caller ID including predetermined identifier “070” or “*”, member company identification information, information of charge amount for present, and mobile communication terminal number information of another user receiving a deposit (charge MIN), via the mobile communication terminal 10 of the user (S401), the micropayment SMS server 400 analyzes the virtual caller ID and transmits an SMS reception acknowledgment message including number information of the mobile communication terminal transmitting the message, the member company identification information, the information of the charge amount for present, and the mobile communication terminal number information of the another user receiving the deposit to the mobile PG center 300 (S402).

When predetermined authentication information is included in the short message received from the mobile communication terminal 10 of the user, as described in the description of FIG. 6, the micropayment SMS server 400 may perform an authentication process based on the user information database 410 before the SMS reception acknowledgment message is transmitted to the mobile PG center 300. The authentication process is not illustrated.

Next, the mobile PG center 300 receiving the SMS reception acknowledgment message checks whether charge information with respect to the member company of the user exists in the charge information database 320 based on the information received from the micropayment SMS server 400 (S403) and transmits an approval message, requesting that the amount requested by the user is charged in the deposit account of the another user, including the mobile communication terminal number information, the information of the charge amount for present, and the mobile communication terminal number information of the user receiving the deposit to the member company server 200 (S404).

In this case, since the mobile communication terminal number information of the user receiving the deposit is not concerned with the payment process, the checked charge information includes the number information of the mobile communication terminal transmitting the message, that is, requesting payment, the member company identification information, and the information of the charge amount for present except the mobile communication terminal number information of the another user receiving the deposit. In case that the charge information including the mobile communication terminal number information of the user, the member company identification information, and the charge amount information stored in the charge information database 320 of the mobile PG center 300 exists, the deposit may be charged as a present regardless of the information of the user receiving the deposit.

In case that the charge information of the user does not exist in the charge information database 320, the mobile PG center 300 transmits an error message including error cause information to the micropayment SMS server 400 (S404-1). The micropayment SMS server 400 transmits a short failure message including the error cause information to the mobile communication terminal 10 (S404-2).

Next, the member company server 200 receiving the approval message from the mobile PG center 300 charges the deposit to the deposit account of the user receiving the deposit according to the information included in the approval message, in which the number information of the mobile communication terminal requesting the payment, the information of the charge amount for present, and the mobile communication terminal number information of the user receiving the deposit are included (S405).

Next, the member company server 200 transmits the present charge result information to the mobile PG center 300, and the mobile PG center 300 transmits the charge result information received from the member company server 200 to the micropayment SMS server 400 (S406).

The micropayment SMS server 400 stores micropayment particulars information in the micropayment particulars database 420 according to the charge result information (S407) and transmits a short message including the present charge result information, that is, micropayment particulars information, to the mobile communication terminal 10 of the user (S408).

On the other hand, in the embodiment of the present invention, a virtual caller ID is generated by a micropayment SMS server. However, a member company server or a mobile PG center may directly generates the virtual caller ID. When the virtual caller ID is generated by the member company server, the member company server generates the virtual caller ID and notifies a user and the mobile PG center, thereby mobile micropayment is started to perform. The process of the mobile micropayment may be changed according to generator of the virtual caller ID therein without departing from the essential points of the present invention

The identifier information composing the virtual caller ID in the embodiment such as “070” or “*” may be replaced by various numbers or letters. The form of the virtual caller ID may be variously changed therein including the information for the mobile micropayment, in addition to a simple combination of identification information, member company identification information, and charge amount information.

Also, in the embodiment, when micropayment is requested by a user, a mobile PG center checks charge information including member company identification information, mobile communication terminal number information of the user, and charge amount information and performs the micropayment. However, the mobile communication terminal number information of the user and the member company identification information are checked, thereby performing the charge in case that past charge amount is not the same as the amount that is presently charged.

In this case, a user may transmit a short message using a virtual caller ID 070-1234-5000 in which a number indicating charge amount is corrected from a virtual caller ID 070-1234-3000 previously acquired to charge desired amount. When a deposit is presented to another user, a short message is transmitted using a virtual caller ID 070-1234-3000-0177890414 in which mobile communication terminal number information of the another user is added or corrected, to present the deposit.

The invention can also be embodied as computer readable codes on a computer readable recording medium. The computer readable recording medium may include program instructions, data files, and data structure individually or associatively. The program instructions and the media may be those specially designed and constructed for the purposes of the present invention, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter.

While this invention has been particularly shown and described with reference to preferred embodiments thereof, various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### INDUSTRIAL APPLICABILITY

According to a micropayment service system and method of the present invention, a user can use mobile micropayment service not only without providing the personal information of the user to a mobile PG center but also by transmitting a short message, and each mobile network operator directly manages the bill particulars information with respect to the mobile micropayment without depending on the mobile PG center.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A mobile micropayment service system using a virtual caller ID, comprising:
a mobile PG center receiving mobile communication terminal number information and charge amount information of a predetermined deposit of a user from a predetermined member company server, generating and storing charge information including the mobile communication terminal number information, the charge amount information, and identification information of the member company, and transmitting the charge information to a predetermined server;
a micropayment SMS server receiving the charge information from the mobile PG center, generating a short payment request message whose calling number is a virtual caller ID including the member company identification information, the charge amount information, and predetermined identification information, wherein the identification information is predetermined number information for receiving a short message from the mobile communication terminal of the user, and transmitting the short payment request message to the mobile communication terminal of the user,
wherein when the short message whose called number is the virtual caller ID is received from the mobile communication terminal, the micropayment SMS server transmits an SMS reception acknowledgment message in response to the short message to the mobile PG center, and when the SMS reception acknowledgment message is received, the mobile PG center transmits an approval message of the approval with respect to the deposit charge to the mobile PG center.

2. The system of claim 1, wherein the virtual caller ID is generated by one of the mobile PG center and the micropayment SMS server.

3. The system of claim 1, wherein the mobile PG center comprises:
a member company information database including a plurality of member company information;
a charge information database storing charge information including user mobile communication terminal number information, member company identification information, and charge amount information;
a charge information storage unit, when a user requests mobile micropayment, the charge information storage unit storing the charge information including the mobile communication terminal number information, the member company identification information, and the charge amount information received from the member company server;
an SMS transmission request unit transmitting the charge information to the micropayment SMS server to request transmitting a short message to the mobile communication terminal of user;
an approval message transmission unit, when an SMS reception acknowledgment message including the mobile communication terminal number information of the user, the member company identification information, and the charge amount information is received from the micropayment SMS server, the approval message transmission unit checking whether charge information corresponding to the SMS reception acknowledgment message exists in the charge information database and transmitting an approval message including the mobile communication terminal number information of user and the charge amount information to the member company server; and
a charge result transmission unit, when charge result information is received from the member company server, the charge result transmission unit transmitting the charge result information to the micropayment SMS server.

4. The system of claim 3, wherein:
when the mobile communication terminal number information of the user, the charge amount information, mobile communication terminal number information of a user, in which a deposit is charged, are received from the member company server, the SMS transmission request unit transmits the mobile communication terminal number information of the user, the charge amount information, the mobile communication terminal number information of the user, in which the deposit is charged, to the micropayment SMS server, and
when the mobile communication terminal number information of the user, the charge amount information, the mobile communication terminal number information of the user, in which the deposit is charged, are received from the micropayment SMS server receiving a short message from the mobile communication terminal, the approval message transmission unit transmits an approval message including the mobile communication terminal number information of the user, the charge amount information, the mobile communication terminal number information of the user, in which the deposit is charged, to the member company server.

5. The system of claim 3, wherein:
when the mobile communication terminal number information of the user, the charge amount information, charge cancellation identifier information are received from the member company, the SMS transmission request unit transmits the mobile communication terminal number information of the user, member company identification information, the charge amount information, the charge cancellation identifier information to the micropayment SMS server, and
when an SMS reception acknowledgment message including the mobile communication terminal number information of the user, the member company identification information, the charge amount information, the charge cancellation identifier information is received from the micropayment SMS server receiving the short message from the mobile communication terminal, the approval message transmission unit transmits an approval message including the mobile communication terminal number information, the charge amount information, and the charge cancellation identifier information to the member company server.

6. The system of claim 3, wherein:
the mobile PG center further includes micropayment particulars database storing micropayment particulars information including the mobile communication terminal number information, the member company identification information, and the charge amount information, and
the charge result transmission unit stores the micropayment particulars information in the micropayment particulars database according to the charge result information received from the member company.

7. The system of claim 1, wherein the micropayment SMS server comprises:
a micropayment particulars database that stores micropayment particulars information including the mobile communication terminal number information, the member company identification information, and the charge amount information;
a payment request SMS transmission unit that transmits a short payment request message requesting a reply of a short message, whose calling number is a virtual caller ID, including the identifier information, the member company identification information, and the charge amount information such that the micropayment SMS server receives the short message from the mobile communication terminal when the mobile communication terminal number information, the member company identification information, and the charge amount information are received from the mobile PG center;
a payment acknowledgment SMS reception unit that acquires information of the virtual caller ID that is a calling number of a short payment acknowledgment message when the payment acknowledgment message is received from the mobile communication terminal;
an SMS reception acknowledgment message transmission unit that transmits an SMS reception acknowledgment message including the mobile communication terminal number transmitting the message, the member company identification information, and the charge amount information acquired from and the virtual caller ID to the mobile PG center, when the virtual caller ID information is received from the payment acknowledgment SMS reception unit; and,
a micropayment particulars storage unit that receives the charge result information transmitted from the member company server via the mobile PG center and stores the micropayment particulars information in the micropayment particulars database for later bill.

8. The system of claim 7, wherein:
when the mobile communication terminal number information of the user, the member company identification information, the charge amount information, and the mobile communication terminal number information of the user, in which the deposit is charged, are received from the mobile PG center, the payment request SMS transmission unit transmits a short payment request message whose calling number is a virtual caller ID including the identifier information used such that the micropayment SMS server receives a short message from the mobile communication terminal, the member company identification information, the charge amount information, and the mobile communication terminal number information of the user, in which the deposit is charged, to the mobile communication terminal, and
when the virtual caller ID information is received from the payment acknowledgment SMS reception unit, the SMS reception acknowledgment message transmission unit transmits an SMS reception acknowledgement message including the number of the mobile communication terminal transmitting the message, the member company identification information, the charge amount information, and the mobile communication terminal number information of the user, in which the deposit is charged, acquired from the virtual caller ID to the mobile PG center.

9. The system of claim 7, wherein:
when the mobile communication terminal number information of the user, the member company identification information, the charge amount information, and charge cancellation identifier information are received from the mobile PG center, the payment request SMS transmission unit transmits a short payment request message whose calling number is a virtual caller ID including the identifier information used such that the micropayment SMS server receives a short message from the mobile communication terminal, the member company identification information, the charge amount information, and the charge cancellation identifier information to the mobile communication terminal, and
when the virtual caller ID information is received from the payment acknowledgment SMS reception unit, the SMS reception acknowledgment message transmission unit transmits an SMS reception acknowledgement message including the number of the mobile communication terminal transmitting the message, the member company identification information, the charge amount information, and the charge cancellation identification information acquired from the virtual caller ID to the mobile PG center.

10. The system of claim 7, wherein:
the micropayment SMS server further comprises a user information database storing authentication information for each user for mobile micropayment and an authentication process unit comparing authentication information included in the short payment acknowledgment message transmitted from the user mobile communication terminal and the authentication information for each user stored in the user information database to process authentication and transmitting authentication result information to the SMS reception acknowledgment message transmission unit;
the payment request SMS transmission unit transmits a short payment request message requesting the user mobile communication terminal to input the user authentication information and reply the message;
when the short payment acknowledgment message including the authentication information is received from the user mobile communication terminal, the payment acknowledgment SMS reception unit transmits the authentication information included in the payment acknowledgement short message to the authentication process unit; and
when the authentication is successively performed by the authentication process unit, the SMS reception acknowledgment message transmission unit transmits an SMS reception acknowledgment message to the mobile PG center, and when authentication performed by the authentication process unit fails, the SMS reception acknowledgment message transmission unit transmits an authentication failure message to the mobile PG center or the user mobile communication terminal.

11. The system of claim 1, wherein:
the mobile micropayment service system further comprises a predetermined member company server, and
the member company server comprises:
a deposit account database storing deposit charge particulars information for each user and deposit account information including deposit balance information;
a deposit account opening unit opening a deposit account with respect to a user and storing opened deposit account information in the deposit account database in case that a deposit charge is initially requested from a terminal of the user connected to Internet;
a micropayment request unit transmitting mobile communication terminal number information of the user and charge amount information to the mobile PG center and requesting payment in case that the mobile communication terminal number information of the user and the charge amount information are transmitted from the user terminal and the deposit charge is requested;
a deposit charge execution unit charging charge amount in the deposit account of the user of the mobile communication terminal according to information included in an approval message in case that the approval message including the mobile communication terminal number information and the charge amount information is received from the mobile PG center; and
a charge result notice unit transmitting charge process result to the mobile PG center when the charge process is finished.

12. The system of claim 11, wherein:
when mobile communication terminal number information of the user, the charge amount information, and number information of a mobile communication terminal of another user, in which a deposit is charged, are transmitted from the user terminal and deposit presentation are requested, the micropayment request unit transmits the mobile communication terminal number information of the user, the charge amount information, and the mobile communication terminal number information of the user, in which the deposit is charged, to the mobile PG center to request payment, and
when the approval message including the mobile communication terminal number information, the charge amount information, and the mobile communication terminal number information of the user, in which the deposit is charged, is received from the mobile PG center, the deposit charge execution unit charges the charge amount in the deposit account with respect to the number of the mobile communication terminal of the user, in which the deposit is charged, according the information include in the approval message.

13. The system of claim 1 wherein:
when the mobile communication terminal number information of the user and the charge amount information are transmitted from the user terminal and deposit charge cancellation is requested, the micropayment request unit transmits the mobile communication terminal number information of the user and the charge amount information, and charge cancellation identifier information to the mobile PG center and requests payment, and
when the approval message including the mobile communication terminal number information, the charge amount information, and charge cancellation identifier information is received from the mobile PG center, the deposit charge execution unit performs charge cancellation with respect to the charge amount on the deposit account of the user according to the information included in the approval message.

14. A mobile micropayment service method for deposit charging of a mobile micropayment service system using a virtual caller ID, the system comprising a micropayment SMS server receiving a short message of a certain virtual caller ID for mobile micropayment from any one of an switch of a mobile communication system and a short message service center, a mobile PG center connected to the micropayment SMS server and a plurality of member company servers, the mobile PG center comprising a charge information database storing mobile communication terminal number information of users, member company identification information, and charge amount information, the method comprising:
a first step of transmitting mobile communication terminal number information, member company identification information, and charge amount information to the micropayment SMS server when the mobile PG center receives the mobile communication terminal number information of the user and the charge amount information from the member company server for the mobile micropayment;
a second step of transmitting a short payment request message whose calling number is a virtual caller ID, the message including the member company identification information and the charge amount information and requesting a short message replying to the mobile communication terminal by the micropayment SMS server;
a third step of transmitting an SMS reception acknowledgment message including the number information of the mobile communication terminal transmitting the short message, the member company identification information, and the charge amount information included in the virtual caller ID to the mobile PG center in case that the micropayment SMS server receives a short payment acknowledgement message transmitted from the mobile communication terminal using the virtual caller ID via the switch or short message service center; and
a fourth step of checking whether charge information including the mobile communication terminal information, the member company identification information, and the charge amount information received from the micropayment SMS server to the mobile PG center exists in the charge information database and transmitting an approval message including the mobile communication terminal number information of the user and the charge amount information to the member company server in case that the charge information exists in the charge information database,
wherein the member company server receiving the approval message from the mobile PG center charges the deposit.

15. The method of claim 14, wherein:
in the first step, when the mobile communication terminal number information of the user and charge amount information for mobile micropayment and the number information of a mobile communication terminal of a user, in which a deposit is charged, are received from the member company server, the mobile PG center further transmits the information of the mobile communication terminal in which the deposit is charged to the micropayment SMS server;
in the second step, the virtual caller ID further comprises the information of the communication terminal number in which the deposit is charged;
in the third step, when a short payment acknowledgment message transmitted using the virtual caller ID from the mobile communication terminal is received, the micropayment SMS server transmits an SMS reception acknowledgment message including the number information of the mobile communication terminal transmitting the message and the member company identification information, the charge amount information, and the information of the communication terminal number in which the deposit is charged included in the virtual caller ID to the mobile PG center; and
in the fourth step, the mobile PG center transmits an approval message including the mobile communication terminal number information of the user, the charge amount information, and the information of the mobile communication terminal number in which the deposit is charged to the member company server.

16. The method of claim 14, wherein:
in the first step, when the mobile communication terminal number of the user, the charge amount information, and the charge cancellation identifier information are received from the member company server, the mobile PG center further transmits the charge cancellation identifier information to the micropayment SMS server;
in the second step, the virtual caller ID further comprises the charge cancellation identifier information;
in the third step, when a short payment acknowledgment message transmitted using the virtual caller ID from the mobile communication terminal is received, the micropayment SMS server transmits an SMS reception acknowledgment message including the information of the mobile communication terminal number transmitting the message, member company identification information, the charge amount information, and charge cancellation identifier information included in the virtual caller ID to the mobile PG center; and
in the fourth step, the mobile PG center transmits an approval message including the mobile communication terminal number information of the user, the charge amount information, and the charge cancellation identifier information to the member company server.

17. The method of claim 14, prior to the first step, further comprising a step of generating charge information including the mobile communication terminal number information of the user, the member company identification information, and the charge amount information and storing the charge information in the charge information database in case that the mobile PG center receives the mobile communication terminal number information of the user and charge amount information from the member company server.

18. The method of claim 14, wherein:
the micropayment SMS server comprises a user information database storing authentication for each user for mobile micropayment;
in the second step, the micropayment SMS server transmits a short payment request message requesting that authentication information of the user is input to reply the message to the mobile communication terminal;
in the third step comprises:
a step of comparing the authentication information included in the short payment acknowledgment message transmitted from the mobile communication terminal with the authentication information of the user stored in the user information database to perform authentication; and
a step of transmitting the SMS reception acknowledgment message to the mobile PG center in case that the authentication is successively performed, and transmitting an authentication failure message to any one of the mobile PG center and the mobile communication terminal of the user in case that the authentication fails.

19. The method of claim 14, wherein the mobile micropayment service system further comprises a member company server connected to the mobile PG center via one of Internet and a private line, the method further comprising:
before the first step, when the member company server receives the mobile communication terminal number and the charge amount information for deposit charge from a user terminal, transmitting the mobile communication terminal number of the user and the charge amount information for the deposit charge to the mobile PG center;
after the fourth step, when the member company server receives the approval message including the mobile communication terminal number of the user and the charge amount is received from the mobile PG center, charging the deposit in the deposit account of the user; and
transmitting charge process result information to the mobile PG center in case that the charge process is finished.

20. The method of claim 19, wherein:
in the step of transmitting the mobile communication terminal number information and the charge amount information by the member company server to the mobile PG center, when the mobile communication terminal number information, the charge amount information, and the mobile communication terminal number, in which the deposit is charged, for deposit presentation are received from the user terminal, the member company server further transmits the mobile communication terminal number information of the user, in which the deposit is charged, to the mobile PG center; and
in the step of charging the deposit by the member company server, when an approval message including the mobile communication terminal number information of the user, the charge amount information, and the information of the mobile communication terminal number, in which the deposit is charged, is received from the mobile PG center, the member company server charges the deposit in the deposit account of the user, in which the deposit is charged, according to the approval message.

21. The method of claim 19, wherein:
in the step of transmitting the mobile communication terminal number information and the charge amount information by the member company server to the mobile PG center, when the mobile communication terminal number information and the charge amount information for deposit charge cancellation are received from the user terminal, the member company server further transmits charge cancellation identifier information to the mobile PG center; and
in the step of charging the deposit by the member company, when an approval message including the mobile communication terminal number information of the user, the charge amount information, and the charge cancellation identifier information is received from the mobile PG center, the member company server cancels deposit charge with respect to the deposit account of the user according to the approval message.

22. A mobile micropayment service method for charging a deposit, of a mobile micropayment service system using a virtual caller ID, the system comprising a micropayment SMS server receiving a short message using a certain virtual caller ID for mobile micropayment from one of an switch of a mobile communication system and a short message service center, a mobile PG center connected to the micropayment SMS server and a plurality of member company servers, the mobile PG center comprising a charge information database storing member company identification information, mobile communication terminal number information of users, and charge amount information, the method comprising:
a first step of transmitting an SMS reception acknowledgment message including information of mobile communication terminal number transmitting a short message, member company identification information, and charge amount information and mobile communication terminal number of a user, in which a deposit is charged, included in the virtual caller ID to the mobile PG center when the micropayment SMS server receives the short message via any one of the switch and the short message service center; and
a second step of checking whether charge information including the mobile communication terminal number information, the member company identification information, and the charge amount information received from the micropayment SMS server to the mobile PG center exists in the charge information database and transmitting an approval message including the mobile communication terminal number information of the user and the charge amount information to the member company server when the charge information exists in the charge information database,
wherein the member company server receiving the approval message from the mobile PG center charges the deposit.

23. The method of claim 22, wherein:
in the first step, when a short message transmitted via virtual caller ID including the member company identification information, the charge amount information, and the information of mobile communication terminal number, in which the deposit is charged, is received from the mobile communication terminal, the micropayment SMS server transmits an SMS reception acknowledgment message including the information of the mobile communication terminal number transmitting the message, the member company identification information, the charge amount information, and the information of the mobile communication terminal number of the user, in which the deposit is charged, to the mobile PG center; and
in the second step, the mobile PG center transmits an approval message including the mobile communication terminal number information of the user, the charge amount information, and the information of the mobile communication terminal number, in which the deposit is charged, to the member company server such that the member company server receiving the approval message from the mobile PG center charges the deposit in the deposit account of the user, in which the deposit is charged.

24. The method of claim 22, wherein:
in the first step, when a short message transmitted via virtual caller ID including the member company identification information, the charge amount information, and charge cancellation identifier information is received from the mobile communication terminal, the micropayment SMS server transmits an SMS reception acknowledgment message including the information of the mobile communication terminal number transmitting the message, the member company identification information, the charge amount information, and the charge cancellation identifier information to the mobile PG center; and
in the second step, the mobile PG center transmits an approval including the mobile communication terminal number information of the user, the charge amount information, and the charge cancellation identifier information to the member company server such that the member company server receiving the approval message from the mobile PG center cancels deposit charge on the deposit account of the user, in which the deposit is charged.

25. The method of claim 22, wherein:
the micropayment SMS server comprises a user information database storing authentication information for each user for mobile micropayment; and
the first step comprises:
a step of comparing authentication information included in the short payment acknowledgment message transmitted from the mobile communication terminal with authentication information of the user stored in the user information database to perform authentication; and
a step of transmitting the SMS reception acknowledgment message to the mobile PG center by the micropayment SMS server in case that the authentication is successively performed, and transmitting an authentication failure message to any one of the mobile PG center and the mobile communication terminal of the user in case that the authentication fails.

26. The method of claim 22, wherein the mobile micropayment service system further comprises a member company server connected to the mobile PG center via any one of Internet and a private line, after the second step, the method further comprising:
a step of charging the deposit in the deposit account of the user of the mobile communication terminal when the member company server receives an approval message including the mobile communication terminal number information of the user and the charge amount information from the mobile PG center; and
a step of transmitting charge result information to the mobile PG center when the charge process is finished.

27. The method of claim 26, wherein in the step of charging the deposit, when the approval message including the mobile communication terminal number information of the user, the charge amount information, and the information of the mobile communication terminal number of the user, in which the deposit is charged, is received from the mobile PG center, the member company server charges the deposit in the deposit account with respect to the mobile communication terminal number, in which the deposit is charged.

28. The method of claim 26, wherein in the step of charging the deposit, when the approval message including the mobile communication terminal number information of the user, the charge amount information, and charge cancellation identifier information is received from the mobile PG center, the member company server cancels deposit charge in the deposit account of the user.

29. The method of claim 28, wherein the step of canceling the charge comprises a step of checking whether charge cancellation is possible and transmitting a deposit charge cancellation failure message to the mobile PG center in case that the cancellation of the deposit charge is impossible, the step of checking and transmitting performed by the member company server.

30. The method of any one of claims 14 and 22, wherein the virtual caller ID is generated by one of the mobile PG center and the micropayment SMS server.

31. The method of any one of claims 14 and 22, wherein the step of transmitting the approval message from the mobile PG center to the member company server comprises:
a step of checking whether the charge information exists in the charge information database;
a step of transmitting an error message from the mobile PG center to the micropayment SMS server in case that the charge information does not exist in the charge information database as a result of the step of checking; and
a step of transmitting a short failure message including information on the error message received from the mobile PG center to the mobile communication terminal of the user, the step of transmitting performed by the micropayment SMS server.

32. The method of any one of claims 14 and 22, wherein the micropayment SMS server comprises a micropayment particulars database storing micropayment particulars information including mobile communication terminal number information, member company identification information, and charge amount information, after the step of transmitting the approval message from the mobile PG center to the member company server, the method further comprising:
a step of transmitting charge result information to the micropayment SMS server when the mobile PG center receives the charge result information from the member company server; and
a step of storing micropayment particulars information according to the charge result information received from the mobile PG center in the micropayment particulars database for later bill, the step performed by the micropayment SMS server.

33. The method of claim 32, after the step of storing the micropayment particulars information in the micropayment particulars database, the method further comprising a step of transmitting a short message including the micropayment particulars information from the micropayment SMS server to the mobile communication terminal of the user.

34. The method of claim 32, wherein the mobile PG center comprises a micropayment particulars database storing micropayment particulars information including the mobile communication number information, member company identification information, and the charge amount information, the method further comprising a step of storing micropayment particulars information according to received charge result information when the mobile PG center receives the charge result information from the member company.
